(19) United States
(12) Patent Application Publication
(10) Pub. No.: US 2015/0115212 A1
(43) Pub. Date: Apr. 30, 2015

(54) PORTABLE AUTOMOBILE LIFT AND METHODS OF USE

(71) Applicant: Mario Vance Gresham, Cartersville, GA (US)

(72) Inventor: Mario Vance Gresham, Cartersville, GA (US)

(21) Appl. No.: 14/288,963

(22) Filed: May 28, 2014

Related U.S. Application Data
(60) Provisional application No. 61/897,416, filed on Oct. 30, 2013.

(51) Int. Cl. B66F 7/06; B66F 7/08

(52) U.S. Cl. CPC B66F 7/0641; B66F 7/08
USPC 254/93 H

(57) ABSTRACT

A portable, lightweight hydraulic lift apparatus that includes a lower frame, an upper frame, and multiple legs connecting the upper and lower frames on which the frames can pivot to place the upper frame either flat on the lower frame or positioned above and in parallel with the lower frame. A hydraulic cylinder mounts to the lower frame at the rear of the lift and to the upper frame at the front of the lift so that as the hydraulic cylinder extends, the upper frame may pivot on the legs and rise, lifting a load above the frame.

### CROSS REFERENCE TO RELATED APPLICATIONS

To the full extent permitted by law, the present United States Non-Provisional patent application claims priority to and the full benefit of United States Provisional patent application entitled “Portable Hydraulic Race Car Lift”, filed on Oct. 30, 2013, having assigned Ser. No. 61/897,416, incorporated entirely herein by reference.

### TECHNICAL FIELD

The disclosure relates generally to automotive repair tools and, more particularly, the disclosure relates to a portable hydraulic automobile lifts and method of raising an automobile off the ground in the field.

### BACKGROUND

Various lifts and car jack mechanism are known in the prior art, such as floor jacks and jack stands utilized to lift a wheel, a quarter section, or one end of an automobile up off the ground for repair or service. Such devices are often heavy, cumbersome and time-consuming to drag about and correctly position under an automobile.

Among these types of car jack mechanism, are so-called “scissor” which can be classified into two kinds: one is a hydraulic scissor car jack and the other is a threaded scissor car jack which compact to carry in a small automobile compartment.

Moreover, at auto race tracks, racers are looking for ways to lower the cost of their racing program, and less expensive portable automobile lift devices are in demand as alternatives to the common heavy and expensive to manufacture existing lifts.

Therefore, it is readily apparent that there is a recognized unmet need for a portable automobile lift and methods of use that is lightweight, portable, inexpensive, and which can be easily carried and positioned under an automobile to lift the entire automobile or one side of the automobile in a matter of seconds.

### BRIEF SUMMARY

Briefly described, in example embodiment, the present apparatus overcomes the above-mentioned disadvantage, and meets the recognized need for a portable automobile lift and methods of use including, in general, a portable, lightweight vehicle hydraulic lift apparatus having a lower frame, an upper frame, and multiple legs connecting the upper and lower frames on which the frames can pivot to place the upper frame either flat on the lower frame or positioned above and in parallel with the lower frame. A hydraulic cylinder mounts to the lower frame at the rear of the lift and to the upper frame at the front of the lift so that as the hydraulic cylinder extends, the upper frame may pivot on the legs and rise, lifting a load above the frame and, thus, functions as an improved a portable automobile lift and methods of use that is lightweight, portable, inexpensive, and which can be easily carried and positioned under an automobile to lift the entire or one side of the automobile in a matter of seconds.

In a preferred exemplary embodiment, the portable vehicle lift assembly, includes a lower stationary frame, an upper moveable frame, each lower stationary frame and the upper moveable frame having a front end and a rear end, and each lower stationary frame and the upper moveable frame having a pair of lengthwise assemblies with a space centered between the lengthwise assemblies, pairs of pivotable legs connecting the lower stationary frame and the upper moveable frame, the pivotable legs having a first end and a second end, and a hydraulic cylinder mounted between the rear end of the lower stationary frame and the front end of the upper moveable frame, and configured to move the upper moveable frame between a lowered position and a raised position.

In a further exemplary embodiment, a portable vehicle lift assembly, includes a pair of lower stationary frames, a pair of upper moveable frames, each of the pair of lower stationary frames and the pair of upper moveable frames having a front end and a rear end, and each of the pair of lower stationary frame and each of the pair of upper moveable frame having a pair of lengthwise assemblies with a space centered between the lengthwise assemblies, pairs of pivotable legs connecting the pair of lower stationary frames and the pair of upper moveable frames, the pivotable legs having a first end and a second end, a front support configured to pivotably connect one of the pairs of pivotable legs of the front end and another one of the pairs of pivotable legs of the front end and a rear support configured to pivotably connect one of the pairs of pivotable legs of the rear end and another one of the pairs of pivotable legs of the rear end, and a hydraulic cylinder mounted between the rear support and the front support to move the upper moveable frame between a lowered position and a raised position.

In still a further exemplary embodiment of the method of raising a vehicle positioned on a surface, including the steps of providing a portable vehicle lift assembly, including a pair of lower stationary frames, a pair of upper moveable frames, each of the pair of lower stationary frames and the pair of upper moveable frames having a front end and a rear end, and each of the pair of lower stationary frame and each of the pair of upper moveable frame having a pair of lengthwise assemblies with a space centered between the lengthwise assemblies, pairs of pivotable legs connecting the pair of lower stationary frames and the pair of upper moveable frames, the pivotable legs having a first end and a second end, a front support configured to pivotably connect one of the pairs of pivotable legs of the front end and another one of the pairs of pivotable legs of the front end and a rear support configured to pivotably connect one of the pairs of pivotable legs of the rear end and another one of the pairs of pivotable legs of the rear end, and a hydraulic cylinder mounted between the rear support and the front support, and transporting as unassembled the portable vehicle lift assembly next to the vehicle.

Accordingly, a feature of the portable automobile lift and methods of use is the ability to provide an automobile lift that is of a rugged, high strength construction, dependable and safe in use, may be readily manufactured and assembled, and may be constructed from economically produced components.

Another feature of the portable automobile lift and methods of use is the ability to provide a portable whole or side automobile lift.

Still another feature of the portable automobile lift and methods of use is the ability to provide a 12 volt hydraulic lift which can be operated in the field.

Yet another feature of portable automobile lift and methods of use is the ability to provide an easy to carry, lightweight, portable, inexpensive, whole or side vehicle lift.

Yet another feature of portable automobile lift and methods of use is the ability to provide a whole vehicle lift capable of lifting the entire automobile at once in a matter of seconds.

Yet another feature of portable automobile lift and methods of use is the ability to provide a vehicle lift capable of lifting one side of the automobile at once in a matter of seconds.

Yet another feature of portable automobile lift and methods of use is the ability to provide a whole or side vehicle lift that is easy to assemble.

These and other features of the portable automobile lift and methods of use will become more apparent to one skilled in the art from the following Detailed Description of the Embodiments and Claims when read in light of the accompanying drawing Figures.

### BRIEF DESCRIPTION OF THE DRAWINGS

The present portable automobile lift and methods of use will be better understood by reading the Detailed Description of the embodiments with reference to the accompanying drawing figures, in which like reference numerals denote similar structure and refer to like elements throughout, and in which:

FIG. 1 is a perspective view of an exemplary portable whole automobile lift shown in a retracted position;

FIG. 2 is a perspective view of the portable whole automobile lift of FIG. 1 shown in an extended position;

FIG. 3 is a side view of the portable whole automobile lift of FIG. 1, shown in a retracted position and positioned under a vehicle;

FIG. 4 is a side view of the portable whole automobile lift of FIG. 2, shown in an extended position and positioned under a raised vehicle;

FIG. 5 is a front view of the portable whole automobile lift of FIG. 4, shown in an extended position and positioned under a raised vehicle;

FIG. 6 is an exploded view of the portable whole automobile lift of FIG. 1;

FIG. 7A is a flow diagram of a method of utilizing portable automobile lift to raise an entire or side of a vehicle; and

FIG. 7B is a flow diagram of a method of utilizing portable automobile lift to raise an entire or side of a vehicle.

It is to be noted that the drawings presented are intended solely for the purpose of illustration and that they are, therefore, neither desired nor intended to limit the disclosure to any or all of the exact details of construction shown, except insofar as they may be deemed essential to the claimed invention.

### DETAILED DESCRIPTION

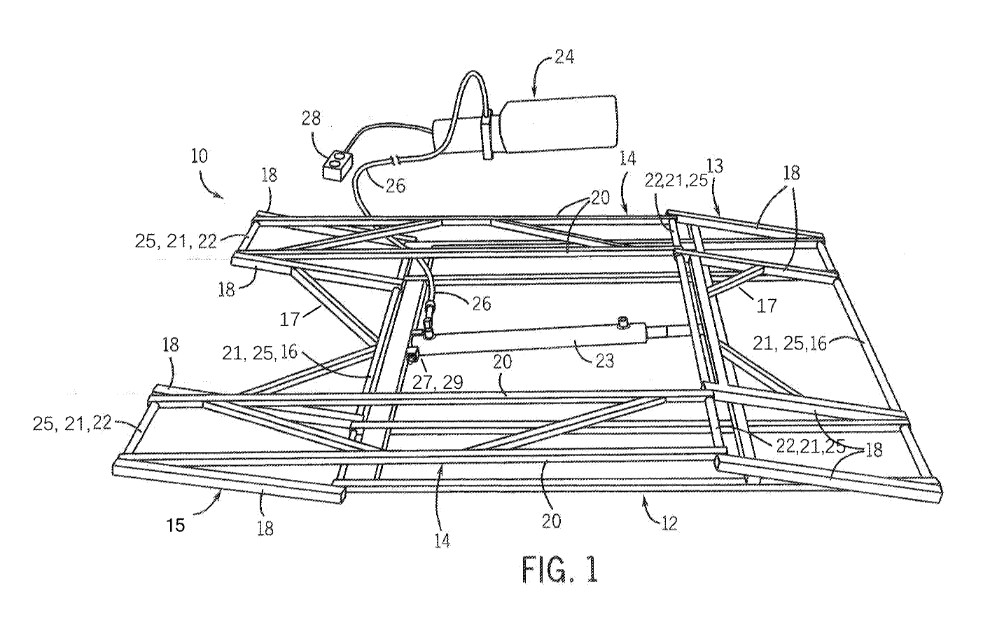

In describing the exemplary embodiments of the present disclosure, as illustrated in FIGS. 1-7 specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

Referring now to FIGS. 1-6 by way of example, and not limitation, therein is illustrated example embodiments of portable automobile lift, such as vehicle lift assembly 10, wherein vehicle lift assembly 10 includes a base or stationary frame, such as lower frame 12, a load rest or moveable frame, such as upper frame 14, a vertical support or multiple legs, such as front frame 13 and rear frame 15 pivotably connecting upper frame 14 and lower frame 12 together on which upper frame 14 and lower frame 12 may preferably pivot to place upper frame 14 either flat laying on lower frame 12 as shown in FIG. 1 or place upper frame 14 positioned above and in parallel with lower frame 12. Preferably, front frame 13 and rear frame 15 pivotably connect thereto lower frame 12 via first hinge mechanism, such as hinge mechanism 25 and front frame 13 and rear frame 15 pivotably connect thereto upper frame 14 via second hinge mechanism, such as hinge mechanism 25. Moreover, a mechanical movement device, such as hydraulic cylinder 23 mounts to lower frame 12 at the rear of vehicle lift assembly 10 or one end of lower frame 12 and to upper frame 14 at the front of vehicle lift assembly 10 or one end of upper frame 14 so that as the hydraulic cylinder extends, the upper frame may pivot on the legs and rise, lifting a load above the frame.

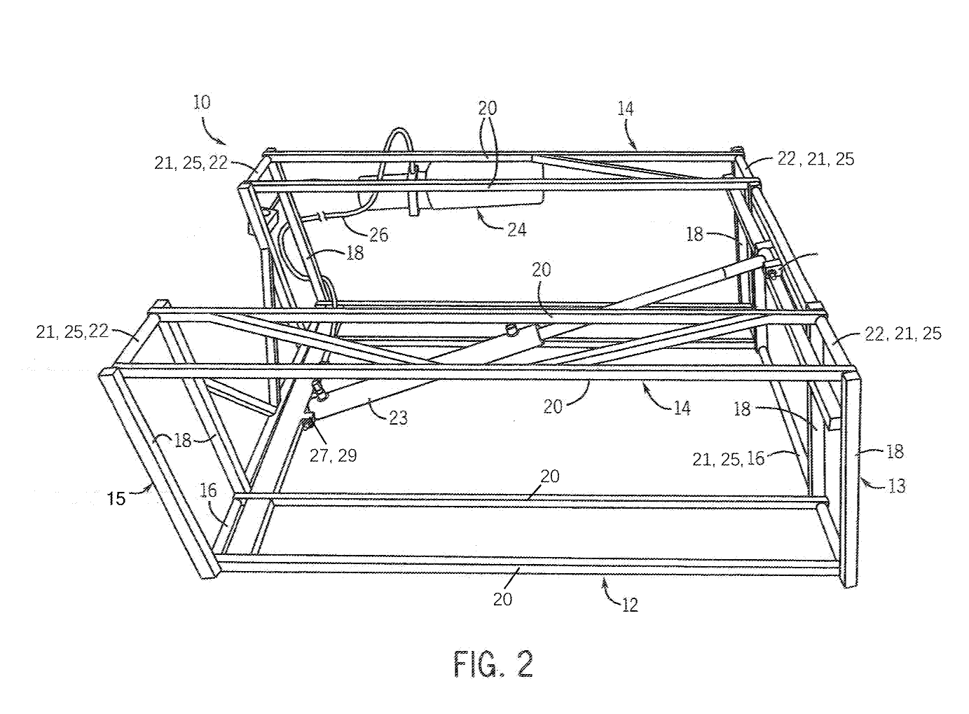

Referring now to FIGS. 1 and 2, by way of example, and not limitation, there is illustrated a perspective views of vehicle lift assembly 10, having assemblies making up lower frame 12, each assembly having two lengthwise assemblies, such as longitudinal elements 20, and may include one or more cross supports to stabilize and strengthen lower frame 12. The completed lower frame 12 may include a pair of assemblies. Moreover, vehicle lift assembly 10, having assemblies making up upper frame 14, each assembly having two longitudinal elements 20, and may include one or more cross supports to stabilize and strengthen upper frame 14. The completed upper frame 14 may include a pair of assemblies. Each assembly having two longitudinal elements 20 preferably about 48 inches in length which may be made from, for example, ¾-inch square tubing of 16 gauge steel. All assemblies making up lower frame 12 and upper frame 14 may include a first hole or aperture, such as apertures 19, formed, drilled, or machined and configured such as, ½-inch diameter holes drilled at ¾-inch from the end of each longitudinal elements 20. For example, the longitudinal elements 20 of lower frame 12 may be joined at the ends of each pair with crosswise tubing, including a front tube and a rear tube, such as short tubing 22, such as about a 6½ inch long pieces of ¾-inch round tubing which may be affixed or welded thereto connect the holes that were drilled to form a member of an assembly pair of lower frame 12. The completed lower frame may include a pair of lower frame 12 assemblies connected one to the other with long tubing 16, such as about a 22-inch length of ¾-inch round 14 gauge tubing which may be affixed or welded thereto connect the holes of the ends of each pair of lower frame 12 assemblies. For example, the two pairs of longitudinal elements 20 of upper frame 14 may be joined at the ends of each pair with tubing 22, such as about a 6½ inch long pieces of ¾-inch round tubing which may be affixed or welded thereto connect the holes that were drilled to form a member of an assembly pair of upper frame 14. The completed upper frame may include a pair of upper frame 14 assemblies connected one to the other with long tubing 16, such as about a 22-inch length of ¾-inch round 14 gauge tubing which may be affixed or welded thereto connect the holes of the ends of each pair of upper frame 14 assemblies.

Preferably, vertical supports or pivotable legs, and pairs, such as leg 18 may include a second hole or aperture, such as apertures 19, such as ¾-inch diameter holes drilled proximately ¾-inch from the end of each leg 18 such as first end and second end leg 18). Preferably leg 18 may be joined at the ends with the end of each longitudinal elements 20, one end to upper frame 14 and the other end to lower frame 12 for preferably total of eight legs 18 or four pairs of legs 18, four legs 18 on front frame 13 and four legs 18 on rear frame 15. Moreover, about a rod or pin, first or second and pairs thereof, such as approximately 42⅜-inch long cold roll 21 may be inserted through aperture 19, such as ¾-inch hole drilled in four of legs 18 of lower left assembly and lower right assembly of front frame 13 and rear frame 15 pivotably connect thereto lower frame 12 via a first hinge mechanism, such as such as hinge mechanism 25. Preferably cold roll 21 may be inserted, affixed or welded thereto the ends of legs 18 to the outside proximately ¾-inch from the end of each end of leg 18. Moreover, a rod or pin, including first and second or pairs, such as approximately a 23⅞-inch long cold roll 21 may be inserted through aperture 19, such as ¾-inch hole drilled in four of legs 18 of upper left assembly and upper right assembly of front frame 13 and rear frame 15 pivotably connect thereto upper frame 14 via hinge mechanism 25. Vertical assemblies of front frame 13 and rear frame 15 may include apertures 19, formed, drilled, or machined and configured such as, ½-inch diameter holes drilled at ¾-inch from the end of each vertical assembly and one centered between the end holes. Preferably cold roll 21 may be affixed or welded thereto the ends of cold roll 21 to the outside proximately ¾-inch from the end of each end of leg 18. Preferably about a ¼-inch long cold roll 21 may be inserted through aperture 19, such as ¾-inch hole drilled in four of legs 18 of upper left assembly and upper right assembly of rear frame 15 pivotably connect thereto upper frame 14 via hinge mechanism 25 in order to leave the center open on rear frame 15 for automobile driveshaft clearance. Preferably cold roll 21 may be inserted affixed or welded thereto the ends of cold roll 21 to the outside proximately ¾-inch from the end of each end of leg 18. Alternatively, about a ⅜-inch long cold roll 21 may be inserted through aperture 19, such as ¾-inch hole drilled in four of legs 18 of upper left assembly and upper right assembly of front frame 13 and rear frame 15 pivotably connect thereto upper frame 14 via hinge mechanism 25. Preferably cold roll 21 may be affixed or welded thereto the ends of cold roll 21 to the outside proximately ¾-inch from the end of each end of leg 18.

It is contemplated herein that front frame 13, rear frame 15, upper frame 14, and/or lower frame 12 may include angle cross supports, such as braces 17 between the lengthwise elements of the assemblies and between the inner rear legs to provide support, strength and rigidity, and such braces 17 may be constructed of ¾-inch square tubing of 16 gauge steel or the like.

Moreover, a mechanical movement device, such as hydraulic cylinder 23 mounts to lower frame 12 at the rear of vehicle lift assembly 10 or one end of lower frame 12 and to upper frame 14 at the front of vehicle lift assembly 10 or one end of upper frame 14 so that as the hydraulic cylinder extends, the upper frame may pivot on the legs and rise from its lowered position shown in FIG. 1, lifting a load above the frame to its lift position shown in FIG. 2. To mount one end of hydraulic cylinder 23, push points 27, such as longitudinal elements 20 preferably one about 42-inch length or two 22-inch length which may be made from, for example, 1-inch square tubing of 16 gauge may be affixed or welded thereto the backside of front frame 13 under the ¾-inch round to serve as a push point 27 for hydraulic cylinder 23. Moreover, to mount the other end of hydraulic cylinder 23, longitudinal elements 20 preferably one about 24-inch length and two about 6.5-inch lengths which may be made from, for example, 1×2-inch rectangular steel tubing may be affixed or welded thereto the backside of rear frame 15 to serve as a push point 27 for hydraulic cylinder 23.

Hydraulic cylinder 23 supports or attachments, such as pairs of tabs 29 which may be made from, for example, about a 1¼ by 1 inch may be affixed or welded thereto push points 29, two on each end directly in the center of push points 29. For example, hydraulic cylinder 23 may be fastened to tabs 29 using for example, about a 5-inch bolts, washers and nuts, or hitch pin and key or the like.

It is recognized that grease fittings may be installed on the eight moving joints where front frame 13, rear frame 15, upper frame 14, and lower frame 12 are pivotably connected, preferably four on upper frame 14 and four on lower frame 12.

Although vehicle lift assembly 10 described may be designed primarily for race cars, it can also be used in automotive shops and by mobile repair services as a portable lift for other vehicles. It is contemplated herein that dual hydraulic cylinder 23 may be required for commercial applications.

It is recognized herein that vehicle lift assembly 10 may be configured with segments of square or round cross-section or other configuration known in the art.

Vehicle lift assembly 10 is preferably formed of a suitable material, such as aluminum, steel, alloy, or combinations thereof or the like, capable of providing structure to vehicle lift assembly 10. Preferably, the material includes other suitable characteristics, such as durability, rust-resistance, light weight, chemical inertness, oxidation resistance, ease of workability, or other beneficial characteristic understood by one skilled in the art.

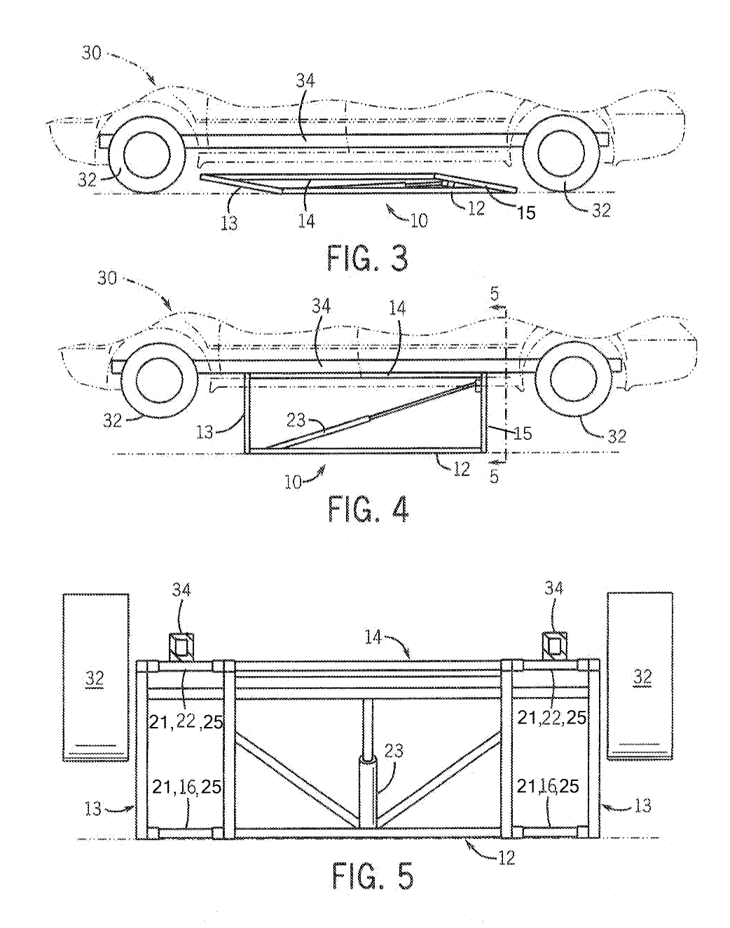

Referring now to FIG. 3, by way of example, and not limitation, there is illustrated vehicle lift assembly 10 shown in a retracted position and positioned under vehicle between vehicle 30 front and rear wheels 32. Each segment of upper frame 14 aligned with vehicle 30 frame, such as frame rails 34. In use, vehicle lift assembly 10 can be carried and positioned beside vehicle 30 and laid on a surface, such as the ground. The user can then slide vehicle lift assembly 10 under vehicle 30 from one side of vehicle 30, as shown in FIG. 3 and centered beneath frame rails 34.

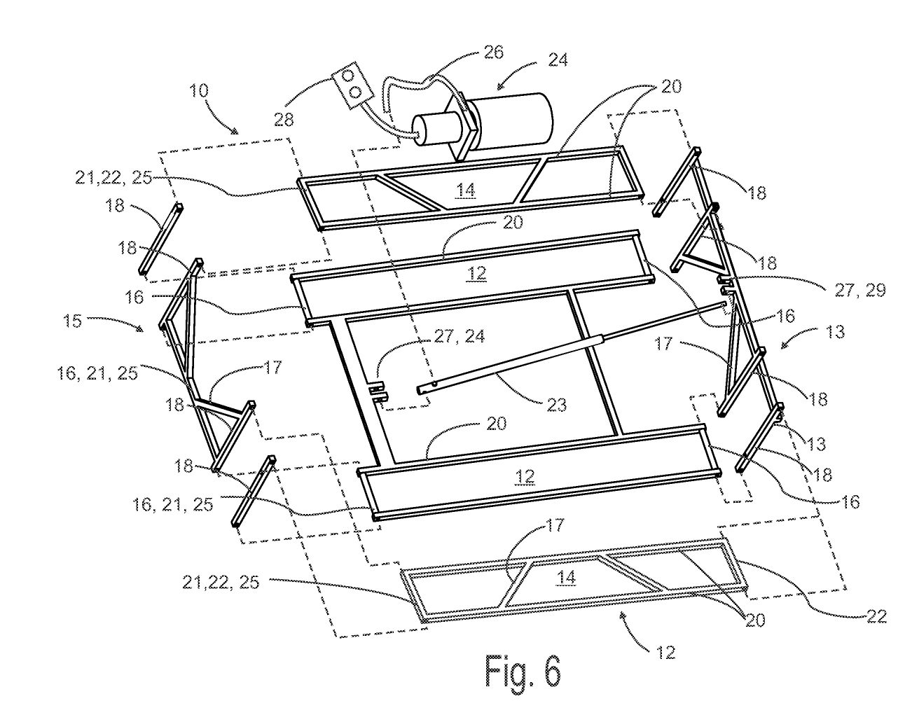

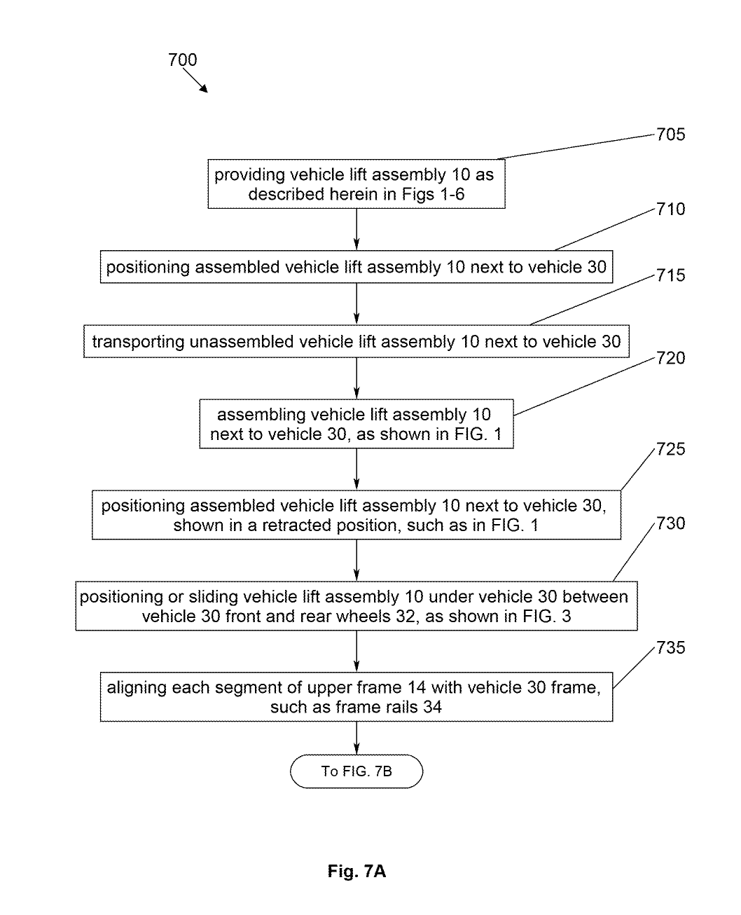

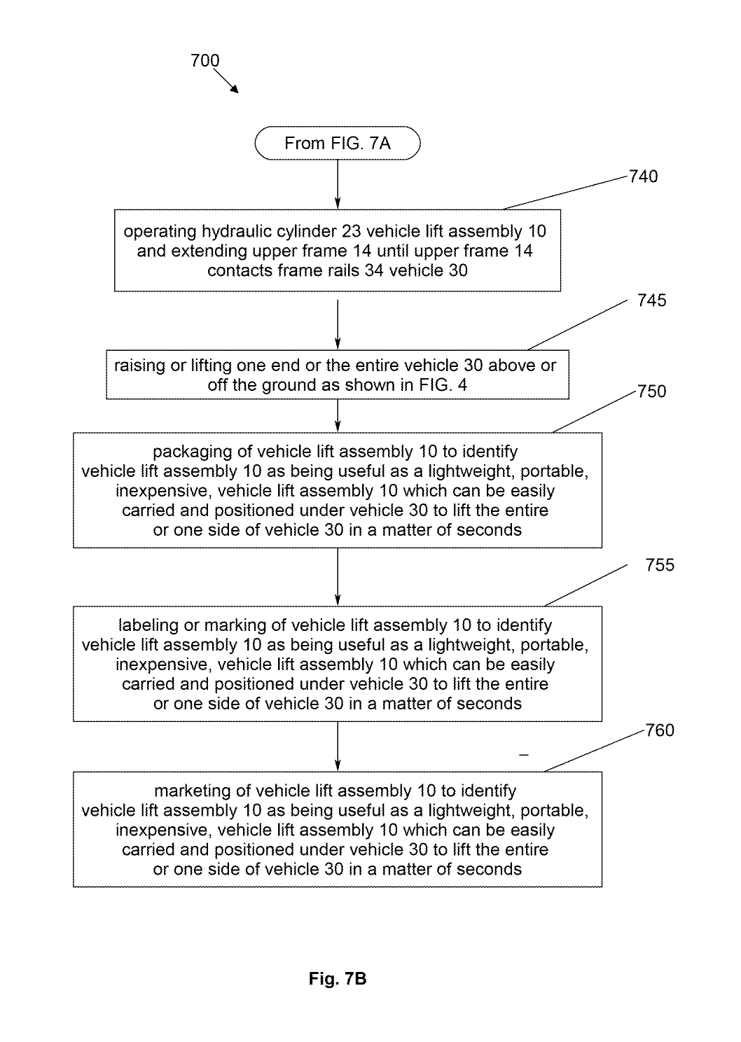

Referring now to FIGS. 4 and 5, by way of example, and not limitation, there is illustrated vehicle lift assembly shown in an extended position and positioned under a raised vehicle 30 between vehicle 30 front and rear wheels 32. Each segment of upper frame 14 aligned with vehicle 30 frame, such as frame rails 34. In use, vehicle lift assembly 10, when hydraulic cylinder 23 is preferably extended, upper frame 14 contacts frame rails 34 and can raise the entire vehicle 30 from the rear to the front of vehicle 30, as shown in FIG. 4. Hydraulic cylinder 23 is preferably extended further until vehicle lift assembly 10 reaches a maximum height, for example, of about 18 inches where front frame 13 and rear frame 15 are perpendicular to lower frame 12 and where front and rear wheels 32 of vehicle 30 are up off the ground.

Referring again to FIGS. 1 and 2, hydraulic cylinder 23 is preferably connected to hydraulic pump mechanism 24 via hose 26. Once hydraulic pump mechanism 24 is activated, vehicle lift assembly 10 can raise upper frame 14 in an upward and forward motion, raising vehicle 30 until hydraulic pump mechanism 24 is shut off, or until vehicle lift assembly 10 reaches a maximum height, for example, of about 18 inches.

Referring again to FIGS. 1-5, when the user may decide to let vehicle 30 down, he can release the hydraulic pressure via controller 28 connected to hydraulic pump mechanism 24, and vehicle lift assembly 10 can gently set vehicle 30 back on the ground. Vehicle lift assembly 10 can then be pulled out by hand from the side of vehicle 30, and can be carried away by a single person to perhaps be stored out of the way.

It is recognized herein that hydraulic pump mechanism 24 may be powered by an external power source or by vehicle 30, such as vehicle 30 12 volt direct current power source.

Referring now to FIG. 6, by way of example, and not limitation, there is illustrated an exploded view of the rigid parts of vehicle lift assembly 10 including first lower frame 12, second lower frame 12, first upper frame 14, second upper frame 14, front frame 13 and rear frame 15 having vertical assemblies with apertures 19, legs 18 having apertures 19, cold roll 21 (preferably cold roll 21 may be inserted therein the ends of legs 18 in aperture 19 proximately ¾-inch from the end of each end of leg 18), pins 42, washer 43, and cotter keys 44 (preferably pins 42 may be inserted therein the ends of legs 18 in aperture 19 proximately ¾-inch from the end of each end of leg 18), and bolts 46 may be utilized to affix inner sets of legs 18 to front frame 13 and rear frame 15, six bolts 46 for front frame 13 and six bolts 46 for rear frame 15.

Referring now to FIGS. 7A and 7B, there is illustrated a flow diagram 700 of a method of lifting vehicle 30. In block or step 705, providing vehicle lift assembly 10, which includes, first lower frame 12, second lower frame 12, first upper frame 14, second upper frame 14, front frame 13 and rear frame 15 having vertical assemblies with apertures 19, legs 18 having apertures 19, cold roll 21 (preferably cold roll 21 may be inserted therein the ends of legs 18 in aperture 19 proximately ¾-inch from the end of each end of leg 18), pins 42, washer 43, and cotter keys 44 (preferably pins 42 may be inserted therein the ends of legs 18 in aperture 19 proximately ¾-inch from the end of each end of leg 18), and bolts 46 may be utilized to affix inner sets of legs 18 to front frame 13 and rear frame 15, six bolts 46 for front frame 13 and six bolts 46 for rear frame 15, respectively as described above in FIGS. 1-6. In block or step 710, transporting unassembled vehicle lift assembly 10 next to vehicle 30. In block or step 715, positioning assembled vehicle lift assembly 10 next to vehicle 30. In block or step 720, assembling vehicle lift assembly 10 next to vehicle 30, as shown in FIG. 1. In block or step 725, positioning assembled vehicle lift assembly 10 next to vehicle 30, shown in a retracted position, such as in FIG. 1. In block or step 730, positioning or sliding vehicle lift assembly 10 under vehicle 30 between vehicle 30 front and rear wheels 32, as shown in FIG. 3. In block or step 735, aligning each segment of upper frame 14 with vehicle 30 frame, such as frame rails 34. In block or step 740, operating hydraulic cylinder 23 vehicle lift assembly 10 and extending upper frame 14 until upper frame 14 contacts frame rails 34 vehicle 30. In block or step 745 raising or lifting one side or the entire vehicle 30 above or off the ground as shown in FIG. 4.

In block or step 750, packaging of vehicle lift assembly 10 to identify vehicle lift assembly 10 as being useful as a lightweight, portable, inexpensive, vehicle lift assembly 10 which can be easily carried and positioned under vehicle 30 to lift the entire or one side of vehicle 30 in a matter of seconds. In block or step 755, labeling or marking of vehicle lift assembly 10 to identify vehicle lift assembly 10 as being useful as a lightweight, portable, inexpensive, vehicle lift assembly 10 which can be easily carried and positioned under vehicle 30 to lift the entire or one side of vehicle 30 in a matter of second. In block or step 760, marketing to identify vehicle lift assembly 10 as being useful as a lightweight, portable, inexpensive, vehicle lift assembly 10 which can be easily carried and positioned under vehicle 30 to lift the entire or one side of vehicle 30 in a matter of second.

The foregoing description and drawings comprise illustrative embodiments of the present invention. Having thus described exemplary embodiments, it should be noted by those ordinarily skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one ordinarily skilled in the art to which this invention pertains having the benefit of the teachings presented in the foregoing descriptions and the associated drawings. Although specific terms may be employed herein, they are used in a generic and descriptive sense only and not for purposes of limitation. Moreover, the present invention has been described in detail; it should be understood that various changes, substitutions and alterations can be made thereto without departing from the spirit and scope of the invention as defined by the appended claims. Accordingly, the present invention is not limited to the specific embodiments illustrated herein, but is limited only by the following claims.

What is claimed is:

1. A portable vehicle lift assembly, the assembly comprising:
a lower stationary frame, an upper moveable frame, each said lower stationary frame and said upper moveable frame having a front end and a rear end, and each said lower stationary frame and said upper moveable frame having a pair of lengthwise assemblies with a space centered between said lengthwise assemblies;
pairs of pivotable legs connecting said lower stationary frame and said upper moveable frame, each of said pivotable legs having a first end and a second end; and
a hydraulic cylinder mounted between said rear end of said lower stationary frame and said front end of said upper moveable frame, and configured to move said upper moveable frame between a lowered position and a raised position.

2. The portable vehicle lift assembly of claim 1, further comprises a first hinge mechanism configured between said lower stationary frame and said first end of said pairs of pivotable legs and a second hinge mechanism configured between said upper moveable frame and said second end of said pairs of pivotable legs.

3. The portable vehicle lift assembly of claim 1, wherein said pair of lengthwise assemblies further comprises a first aperture positioned proximate each of said front end and said rear end.

4. The portable vehicle lift assembly of claim 3, wherein said pair of lengthwise assemblies further comprises a crosswise tubing affixed between said first aperture of said front end of said pair of lengthwise assemblies and between said rear end of said pair of lengthwise assemblies.

5. The portable vehicle lift assembly of claim 4, wherein each of said pairs of pivotable legs further comprises a second aperture positioned proximate each of said first end and said second end of said pairs of pivotable legs.

6. The portable vehicle lift assembly of claim 5, further comprises a first pair of pins, each of said first pair of pins configured to inserted therethrough said second aperture of said pivotable legs positioned adjacent said pair of lengthwise assemblies of said lower stationary frame.

7. The portable vehicle lift assembly of claim 5, further comprises a second pair of pins, each of said second pair of pins configured to inserted therethrough said second aperture of said pivotable legs positioned adjacent said pair of lengthwise assemblies of said upper moveable frame.

8. The portable vehicle lift assembly of claim 1, further comprises one or more cross supports configured to stabilize said pair of lengthwise assemblies.

9. A portable vehicle lift assembly, the assembly comprising:
a pair of lower stationary frames, a pair of upper moveable frames, each of said pair of lower stationary frames and said pair of upper moveable frames having a front end and a rear end, and each of said pair of lower stationary frame and each of said pair of upper moveable frame having a pair of lengthwise assemblies with a space centered between said pair of lengthwise assemblies;
pairs of pivotable legs connecting said pair of lower stationary frames and said pair of upper moveable frames, each of said pivotable legs having a first end and a second end;
a front support configured to pivotably connect one of said pairs of pivotable legs of said front end and another one of said pairs of pivotable legs of said front end and a rear support configured to pivotably connect one of said pairs of pivotable legs of said rear end and another one of said pairs of pivotable legs of said rear end; and
a hydraulic cylinder mounted between said rear support and said front support to move said upper moveable frame between a lowered position and a raised position.

10. The portable vehicle lift assembly of claim 9, further comprises a first hinge mechanism configured between said lower stationary frame and said first end of said pairs of pivotable legs and a second hinge mechanism configured between said upper moveable frame and said second end of said pairs of pivotable legs.

11. The portable vehicle lift assembly of claim 9, wherein said hydraulic cylinder causes said upper moveable frame to rise above said lower stationary frame as said pairs of pivotable legs become upright.

12. The portable vehicle lift assembly of claim 9, wherein said pair of lengthwise assemblies further comprises a first aperture positioned proximate each of said front end and said rear end.

13. The portable vehicle lift assembly of claim 12, wherein said pair of lengthwise assemblies further comprises a crosswise tubing affixed between said first aperture of said front end of said pair of lengthwise assemblies and between said rear end of said pair of lengthwise assemblies.

14. The portable vehicle lift assembly of claim 13, wherein each of said pairs of pivotable legs further comprises a second aperture positioned proximate each of said first end and said second end of said pairs of pivotable legs.

15. The portable vehicle lift assembly of claim 14, further comprises a first pair of pins, each of said first pair of pins configured to inserted therethrough said second aperture of said pair of pivotable legs positioned adjacent said pair of lengthwise assemblies of said lower stationary frame.

16. The portable vehicle lift assembly of claim 14, further comprises a second pair of pins, each of said second pair of pins configured to inserted therethrough said second aperture of said pair of pivotable legs positioned adjacent said pair of lengthwise assemblies of said upper moveable frame.

17. The portable vehicle lift assembly of claim 9, further comprises one or more cross supports configured to stabilize said front support and said rear support.

18. The portable vehicle lift assembly of claim 16, further comprises a first pair of rods, one of said first pair of rods configured to extend therebetween said front end of said pair of lower stationary frames and another of said first pair of rods configured to extend therebetween said rear end of said pair of lower stationary frames.

19. The portable vehicle lift assembly of claim 16, further comprises a second pair of rods, one of said second pair of rods configured to extend therebetween said front end of said pair of upper moveable frames and another of said second pair of rods configured to extend therebetween said rear end of said pair of upper moveable frames.

20. A method raising a vehicle positioned on a surface, comprising the steps of:
providing a portable vehicle lift assembly, including a pair of lower stationary frames, a pair of upper moveable frames, each of said pair of lower stationary frames and said pair of upper moveable frames having a front end and a rear end, and each of said pair of lower stationary frame and each of said pair of upper moveable frame having a pair of lengthwise assemblies with a space centered between said pair of lengthwise assemblies, pairs of pivotable legs connecting said pair of lower stationary frames and said pair of upper moveable frames, each of said pairs of pivotable legs having a first end and a second end, a front support configured to pivotably connect one of said pairs of pivotable legs of said front end and another one of said pairs of pivotable legs of said front end and a rear support configured to pivotably connect one of said pairs of pivotable legs of said rear end and another one of said pairs of pivotable legs of said rear end, and a hydraulic cylinder mounted between said rear support and said front support; and
transporting as unassembled said portable vehicle lift assembly next to the vehicle.

21. The method of claim 20, further comprising the step of assembling said portable vehicle lift assembly.

22. The method of claim 21, further comprising the step of sliding the portable vehicle lift assembly under the vehicle.

23. The method of claim 22, further comprising the step of operating said hydraulic cylinder of said portable vehicle lift assembly to move said upper moveable frame between a lowered position and a raised position.

24. The method of claim 23, further comprising the step of lifting the vehicle above the surface.

25. The method of claim 20, further comprising the step of packaging the portable vehicle lift assembly as being useful as a lightweight, portable, vehicle lift configured to be carried and positioned under the vehicle.

26. The method of claim 20, further comprising the step of marketing the portable vehicle lift assembly as being useful as a lightweight, portable, vehicle lift configured to be carried and positioned under the vehicle.
